(19) United States
(12) Patent Application Publication
(10) Pub. No.: US 2005/0131144 A1
(43) Pub. Date: Jun. 16, 2005

(54) Surface-active block copolymers prepared by controlled radical polymerization

(76) Inventors: Herve Adam, Princeton, NJ (US); Pascal Herve, West Windsor, NJ (US); Mathieu Joanicot, Lawrenceville, NJ (US); Wan-Li Liu, Belle Mead, NJ (US); Maria Ruela Talingting, Burlington, NJ (US)

Correspondence Address: Rhodia Inc., CN 7500, 259 Prospect Plains Road, CRANBURY, NJ, 08512, US

(21) Appl. No.: 11/047,940

(22) Filed: Feb. 1, 2005

Related U.S. Application Data
(63) Continuation of application No. 10/137,945, filed on May 2, 2002.
(60) Provisional application No. 60/288,844, filed on May 4, 2001.

(51) Int. Cl. C08L 9/00

(52) U.S. Cl. 525/98

(57) ABSTRACT

A subject-matter of the present invention is a surface-active block copolymer comprising at least one hydrophilic block and at least one hydrophobic block which is prepared by a “living” or “controlled” preparation process, the said copolymer exhibiting a number-average molecular mass of between 1 000 and 50 000, preferably between 2 000 and 20 000, more preferably still between 4 000 and 16 000, a glass transition temperature of the hydrophobic block of less than 30° C., preferably of less than 25° C., and greater than −100° C., and a surface tension of less than 60 millinewtons per metre (mN/m), preferably of less than 50 mN/m, measured at a concentration in demineralized water of less than or equal to 10⁻⁴ mol/l, and the transfer agent optionally having been rendered inert with respect to the said radical polymerization. The copolymers obtained can be used in particular in detergency or in paints, adhesives and building materials.

This application claims priority under 35 U.S.C. §§ 119 and/or 365 to 60/288,844 filed in the United States on May 04, 2001, the entire content of which is hereby incorporated by reference.

A subject-matter of the present invention is surface-active block copolymers prepared by controlled radical polymerization and a process for the preparation of said copolymers.

A subject-matter of the present invention is thus a surface-active block copolymer comprising at least one hydrophilic block and at least one hydrophobic block which is prepared by a “living” preparation process using a transfer agent, the said copolymer exhibiting:
a number-average molecular mass of between 1 000 and 50 000, preferably between 2 000 and 20 000, more preferably still between 4 000 and 16 000,
a glass transition temperature of the hydrophobic block of less than 30° C., preferably of less than 25° C., and greater than −100° C., and
a surface tension of less than 60 millinewtons per metre (mN/m), preferably of less than 50 mN/m, measured at a concentration in demineralized water of less than or equal to 10⁻⁴ mol/l at 20° C. and under one atmosphere.

Optionally, for some applications of the copolymers, it is preferable to render chemically inert the transfer agent located at one of the ends of the molecule or else to destroy the said agent.

Other advantages and characteristics of the present invention will become more clearly apparent on reading the description and examples which will follow.

According to the invention, surface-active block copolymers comprising at least one hydrophilic block and at least one hydrophobic block are prepared by a “living” or “controlled” radical polymerization process involving the use of a transfer agent specifically for the purpose of controlling the said radical polymerization. The hydrophilic block preferably derives from hydrophilic monomers, and the hydrophobic block preferably derives from hydrophobic monomers.

Generally, the preceding block copolymers can be obtained by any “living” or “controlled” polymerization process, such as, for example:
radical polymerization controlled by xanthates according to the teaching of Application WO 98/58974,
radical polymerization controlled by dithioesters according to the teaching of Application WO 98/01478,
polymerization using nitroxide precursors according to the teaching of Application WO 99/03894,
radical polymerization controlled by dithiocarbamates according to the teaching of Application WO 99/31144,
atom transfer radical polymerization (ATRP) according to the teaching of Application WO 96/30421,
radical polymerization controlled by iniferters according to the teaching of Otu et al., Makromol. Chem. Rapid. Commun., 3, 127 (1982),
radical polymerization controlled by degenerative transfer of iodine according to the teaching of Tatemoto et al., Jap. 50, 127, 991 (1975), Daikin Kogyo Co Ltd Japan, and Matyjaszewski et al., Macromolecules, 28, 2093 (1995),
group transfer polymerization according to the teaching of Webster O. W., “Group Transfer Polymerization”, p. 580-588, in the “Encyclopedia of Polymer Science and Engineering”, Vol. 7, edited by H. F. Mark, N. M. Bikales, C. G. Overberger and G. Menges, Wiley Interscience, New York, 1987,
radical polymerization controlled by tetraphenylethane derivatives (D. Braun et al., Macromol. Symp., 111, 63 (1996)),
radical polymerization controlled by organocobalt complexes (Wayland et al., J. Am. Chem. Soc., 116, 7973 (1994)).

The preferred transfer agents for implementing the controlled polymerization process are chosen from dithioesters, thioethers-thiones, dithiocarbamates and xanthates.

The preferred polymerization is the living radical polymerization using xanthates.

The invention additionally relates to a process for the preparation of these block polymers.

This process consists in:

1—bringing into contact:
at least one ethylenically unsaturated monomer,
at least one source of free radicals, and
at least one transfer agent of formula (I): 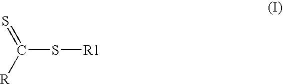
   in which:
R represents an R2O—, R2R′2N— or R3- group with: R2 and R′2, which are identical or different, representing (i) an alkyl, acyl, aryl, alkene or alkyne group or (ii) an optionally aromatic, saturated or unsaturated carbonaceous ring or (iii) a saturated or unsaturated heterocycle, it being possible for these groups and rings (i), (ii) and (iii) to be substituted, R3 representing H, Cl, an alkyl, aryl, alkene or alkyne group, an optionally substituted, saturated or unsaturated (hetero)cycle, an alkylthio, alkoxycarbonyl, aryloxycarbonyl, carboxyl, acyloxy, carbamoyl, cyano, dialkyl- or diarylphosphonato, or dialkyl- or diarylphosphinato group, or a polymer chain,
R1 represents (i) an optionally substituted alkyl, acyl, aryl, alkene or alkyne group or (ii) a carbonaceous ring which is saturated or unsaturated and which is optionally subsituted or aromatic or (iii) an optionally substituted, saturated or unsaturated heterocycle or a polymer chain, and

2—repeating, at least once, the above operation of bringing into contact using:
different monomers from the preceding implementation, and
instead of the precursor compound of formula (I), the polymer resulting from the preceding implementation, and

3—rendering the transfer agent inert at the end of the polymerization.

The R1, R2, R′2 and R3 groups can be substituted by substituted phenyl or alkyl groups, substituted aromatic groups or the following groups: oxo, alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, isocyanato, phthalimido, maleimido, succinimido, amidino, guanidino, hydroxyl (—OH), amino (—NR₂), halogen, allyl, epoxy, alkoxy (—OR), S-alkyl, S-aryl or silyl, groups exhibiting a hydrophilic or ionic nature, such as alkaline salts of carboxylic acids or alkaline salts of sulphonic acid, poly(alkylene oxide) (PEO, PPO) chains, or cationic substituents (quaternary ammonium salts), R representing an alkyl or aryl group.

Preferably, the transfer agent of formula (I) is a dithiocarbonate chosen from the compounds of following formulae (IA), (IB) and (IC): 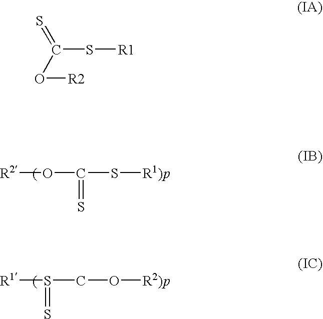
in which:
R2 and R2′ represent (i) an alkyl, acyl, aryl, alkene or alkyne group or (ii) an optionally aromatic, saturated or unsaturated carbonaceous ring or (iii) a saturated or unsaturated heterocycle, it being possible for these groups and rings (i), (ii) and (iii) to be substituted,
R1 and R1′ represent (i) an optionally substituted alkyl, acyl, aryl, alkene or alkyne group or (ii) a carbonaceous ring which is saturated or unsaturated and which is optionally subsituted or aromatic or (iii) an optionally substituted, saturated or unsaturated heterocycle or a polymer chain,
p is between 2 and 10.

During Stage 1, a first block of the polymer is synthesized with a hydrophilic or hydrophobic nature, according to the nature and the amount of the monomers used. During Stage 2, the other block of the polymer is synthesized.

The ethylenically unsaturated monomers are chosen from hydrophilic and hydrophobic monomers in the proportions appropriate for obtaining a surface-active block copolymer, the blocks of which exhibit the characteristics of the invention. According to this process, if all the successive polymerizations are carried out in the same reactor, it is generally preferable for all the monomers used during one stage to have been consumed before the polymerization of the following stage begins, therefore before the new monomers are introduced. However, it may happen that the hydrophobic or hydrophilic monomers of the preceding stage are still present in the reactor during the polymerization of the following block. In this case, these monomers generally do not represent more than 5 mol % of all the monomers and they participate in the following polymerization by contributing to the introduction of the hydrophobic or hydrophilic units into the following block.

The surface-active block copolymers prepared according to this polymerization process can be simply diblocks, with a hydrophobic block and a hydrophilic block, or even triblocks, with either a hydrophilic block framed by two hydrophobic blocks or a hydrophobic block framed by two hydrophilic blocks.

More particularly, the surface-active block copolymer can be obtained by employing, as hydrophilic monomer for the purpose of preparing the hydrophilic block, at least one ethylenically unsaturated monomer chosen from:
unsaturated ethylenic mono- and dicarboxylic acids, such as acrylic acid, methacrylic acid, itaconic acid, maleic acid or fumaric acid,
monoalkyl esters of the dicarboxylic acids of the type mentioned with alkanols preferably having 1 to 4 carbon atoms and their N-substituted derivatives, such as, for example, 2-hydroxyethyl acrylate or methacrylate,
amides of unsaturated carboxylic acids, such as acrylamide or methacrylamide,
ethylenic monomers comprising a sulphonic acid group and its alkali metal or ammonium salts, for example vinylsulphonic acid, vinylbenzenesulphonic acid, alpha-acrylamidomethylpropanesulphonic acid or 2-sulphoethyl methacrylate.

However, the most preferred hydrophilic monomers are acrylic acid (AA), acrylamide (AM), 2-acrylamido-2-methylpropanesulphonic acid (AMPS) and styrenesulphonate (SS).

Mention may in particular be made, as illustration of hydrophobic monomers which can be used to prepare the hydrophobic block, of (meth)acrylic esters, vinyl esters and vinyl nitriles.

The term “(meth)acrylic esters” denotes esters of acrylic acid and of methacrylic acid with hydrogenated or fluorinated C₁-C₁₂ alcohols, preferably C₁-C₈ alcohols. Mention may be made, among the compounds of this type, of: methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate or isobutyl methacrylate. The preferred monomers are the esters of acrylic acid with linear or branched C₁-C₄ alcohols, such as methyl, ethyl, propyl and butyl acrylate.

The vinyl nitriles include more particularly those having from 3 to 12 carbon atoms, such as, in particular, acrylonitrile and methacrylonitrile. The other ethylenically unsaturated monomers, which can be used alone or as mixtures, or which can be copolymerized with the above monomers, are in particular:
carboxylic acid vinyl esters, such as vinyl acetate, vinyl versatate or vinyl propionate,
vinyl halides,
vinylamine amides, in particular vinylformamide or vinylacetamide,
unsaturated ethylenic monomers comprising a secondary, tertiary or quaternary amino group or a heterocyclic group comprising nitrogen, such as, for example, vinylpyridines, vinylimidazole, aminoalkyl (meth)acrylates and aminoalkyl(meth)acrylamides, such as dimethylaminoethyl acrylate or methacrylate, di-tert-butylaminoethyl acrylate or methacrylate, or dimethylaminomethylacrylamide or -methacrylamide.

It is very obviously possible to include, in the composition of the block copolymers, a certain proportion of hydrophobic monomers in the hydrophilic block and a certain proportion of hydrophilic monomers in the hydrophobic block, provided that the surface-active properties and the limits of the number-average molecular mass, of the glass transition temperature of the hydrophobic group and of surface tension are adhered to.

The polymerization of the copolymer can be carried out in an aqueous and/or organic solvent medium, such as tetrahydrofuran or a linear, cyclic or branched C₁-C₈ aliphatic alcohol, such as methanol, ethanol or cyclohexanol, or a diol, such as ethylene glycol. An alcoholic solvent is more particularly recommended in the case where the hydrophilic monomers are acrylic acid (AA), acrylamide (AM), 2-acrylamido-2-methylpropanesulphonic acid (AMPS) and styrenesulphonate (SS) and the hydrophobic monomers are n-butyl acrylate, isobutyl acrylate, 2-ethylhexyl acrylate or t-butyl acrylate.

At the end of the controlled polymerization stage, the transfer agent, located at one of the chain ends of the surface-active block polymer, can be rendered inert, if desired, for the final use of the copolymer. It is possible for the nature of the polymerization reaction medium (for example, pH conditions, nature of the constituents of the reaction medium, monomers to be polymerized) to be sufficient per se to inactivate the transfer agent at the end of polymerization. It is also possible for the medium to be treated during the final use of the copolymer to intrinsically inactivate or neutralize the transfer agent. It is recommended, if this is necessary for certain applications, to mask the active chemical functional groups of the said agent by means of a suitable chemical masking agent or to destroy the transfer agent by a hydrolysis or oxidation reaction by metal catalysis or by the use of primary radicals. In the case of xanthate as transfer agent, it is recommended to render it inert, if necessary, by treatment of the copolymer formed by means of a heat treatment, for example in the temperature range 80 to 180° C., in the presence of an alcoholamine, such as triethanolamine.

The present invention also relates to the preparation of block copolymers which, in addition to their surface-active properties and properties of stabilizing aqueous emulsions, lower the surface tension of water and result in the formation of micelles and/or of small vesicles in suspension in water, within which entities a chemical reaction can be carried out or an active principle can be encapsulated. The invention also relates to the use of the preceding block copolymers as adhesion promoters. They can also be used as wetting agents or hydrophilizing agents for the coating of more or less hydrophobic surfaces with an effect which persists after rinsing. Preferably, the polymers can be used in an amount generally of between 0.1% and 10% by weight with respect to the aqueous medium. The block copolymers according to the invention exert in particular the advantage of improving the adhesion of paints to hydrophobic substrates, such as plastic substrates, and of enhancing the adhesion of plastic fibres and supports to compounds resulting from aqueous dispersions (cement, mastics). In this specific application as adhesion agents, it is recommended to use from 0.1 to 10%, preferably from 0.5 to 5%, by weight of copolymer with respect to the total weight of the paint. In the application as wetting agents in an aqueous solution, it is recommended to use an amount of 0.01 to 3%, preferably of 0.1 to 1%, by weight of copolymer with respect to the total weight of the said solution.

The block copolymers according to the invention are also promoters of conventional detergent agents, such as alkylbenzenesulphonates, when they are used in combination with the latter at a dose preferably of between 0.5 and 5% by weight with respect to the weight of the detergent.

In the specific case of a poly(butyl acrylate)/poly(acrylic acid) block copolymer, recorded as p(BA)-b-p(AA), according to the invention, the range of following properties exists by varying the p(BA)/p(AA) ratios by mass in the following way:

surface active properties and properties of stabilizing aqueous emulsions:
p(BA)/p(AA) of between 10/90 and 40/60;

formation of vesicles:
p(BA)/p(AA) of between 70/30 and 80/20; and

adhesion promoters and wetting agents:
p(BA)/p(AA) of between 70/30 and 40/60.

At the end of the controlled polymerization stage, the transfer agent, located at one of the chain ends of the surface-active block polymer, can be rendered chemically inert by any suitable means. The fact of rendering the transfer agent inert can be advantageous for certain applications. It is then recommended to mask the active chemical functional groups of the said agent by means of a suitable chemical masking agent or to destroy the transfer agent by a hydrolysis or oxidation reaction by metal catalysis or by the use of primary radicals.

Concrete but nonlimiting examples of the invention will now be presented.

In the examples which follow:
Mn represents the number-average molecular mass Mn of the polymers; Mn is expressed in polystyrene equivalents (g/mol),
Mw represents the weight-average molecular mass (g/mol),
Mw/Mn represents the polydispersity index.
the polymers, before hydrolysis, are analysed by chromatography (GPC) with THF as elution solvent.

The following examples illustrate the preparation of surface-active diblock copolymers according to the invention:

### EXAMPLE 1

### Preparation of a 50/50 by 2eight p(BA)-b-p(AA) (poly(butyl acrylate)-poly(acrylic acid)) diblock polymer comprising a reactive end of the xanthate type

The following mixture:
3.04 g of xanthate-A, S-ethylpropionyl O-ethyl dithiocarbonate (hereinafter known as xanthate),
21.24 g of isopropanol, and
0.82 g of azobisisobutyronitrile (AIBN),
   is introduced into a reactor equipped with a magnetic stirrer and a reflux column and comprising 160 g of acetone.

The mixture is subsequently stirred and maintained at reflux at 70° C. 66 g of acrylic acid (AA) and 15 g of water are added gradually over 3 hours. 0.41 g of azobisisobutyronitrile is then added after one hour of addition and then a further 0.41 g of azobisisobutyronitrile is added after a second hour of addition. Once the addition of acrylic acid is complete, the polymerization is allowed to continue for another hour. An amount of 0.20 g of reaction mixture is withdrawn as sample of PAA homopolymer.

The temperature is subsequently lowered to 65° C. by addition of 560 g of acetone. 140 g of butyl acrylate (BA) are gradually added over 3 hours while maintaining the temperature at 65° C. 0.40 g of AIBN is added at the beginning of the addition of BA. The reaction is allowed to continue for a further 3 hours. The reaction mixture is allowed to cool and the solvents are virtually completely removed using a rotavapor (rotary evaporator). The residue obtained is dispersed in water and lyophilized. The polymers are analysed by carbon-13 nuclear magnetic resonance and by measuring their acid content.
The number-average molecular mass of the copolymer is 15 000.
The glass transition temperature of the hydrophobic block is −54° C.
The surface tension is 55 mN/m at 10⁻⁴ mol/l.

### EXAMPLE 2

### Preparation of a 70/30 by weight p(BA)-b-p(AA) (poly(butyl acrylate)-poly(acrylic acid)) diblock polymer comprising a reactive end of the xanthate type

The following mixture:
0.61 g of xanthate-A, S-ethylpropionyl O-ethyl dithiocarbonate (hereinafter known as xanthate),
4.25 g of isopropanol,
0.16 g of azobisisobutyronitrile,
   is introduced, under a nitrogen atmosphere, into a reactor equipped with a magnetic stirrer and a reflux column and comprising 160 g of acetone.

The mixture is subsequently stirred and maintained at reflux at 70° C. 13.2 g of acrylic acid (AA) and 30.3 g of water are added gradually over 3 hours. 0.08 g of azobisisobutyronitrile is then added after one hour of addition and then a further 0.08 g of azobisisobutyronitrile is added after a second hour of addition. Once the addition of acrylic acid is complete, the polymerization is allowed to continue for another hour. An amount of 4.1 g of reaction mixture is withdrawn as sample of PAA homopolymer.

The temperature is subsequently lowered to 65° C. by addition of 112 g of acetone. 28 g of butyl acrylate (BA) are gradually added over 3 hours while maintaining the temperature at 65° C. 0.08 g of AIBN is added at the beginning of the addition of BA. The nitrogen purge is halted and the reaction is allowed to continue for a further 12 hours. The reaction mixture is allowed to cool and the solvents are virtually completely removed using a rotavapor (rotary evaporator). The residue obtained is dispersed in water and lyophilized. The polymers are analysed by carbon 13 nuclear magnetic resonance and by measuring their acid content.
The number-average molecular mass is 15 000.
The glass transition temperature of the hydrophobic block is: −54° C.
The surface tension is 52 mN/m at 10⁻⁴ mol/l.

### EXAMPLE 3

### Preparation of a 60/40 by weight p(BA)-b-p(AA) (poly(butyl acrylate)-poly(acrylic acid)) diblock polymer comprising a reactive end of the xanthate type

The following mixture:
1.53 g of xanthate-A, S-ethylpropionyl O-ethyl dithiocarbonate (hereinafter known as xanthate),
10.72 g of isopropanol, and
0.42 g of azobisisobutyronitrile (AIBN),
   is introduced into a reactor equipped with a magnetic stirrer and a reflux column and comprising 160 g of acetone.

The mixture is subsequently stirred and maintained at reflux at 70° C. 44.0 g of acrylic acid (AA) and 75.4 g of water are added gradually over 3 hours. 0.21 g of azobisisobutyronitrile is then added after one hour of addition and then a further 0.21 g of azobisisobutyronitrile is added after a second hour of addition. Once the addition of acrylic acid is complete, the polymerization is allowed to continue for another hour. An amount of 10.98 g of reaction mixture is withdrawn as sample of PAA homopolymer.

The temperature is subsequently lowered to 65° C. by addition of 280 g of acetone. 60 g of butyl acrylate (BA) are gradually added over 3 hours while maintaining the temperature at 65° C. 0.20 g of AIBN is added at the beginning of the addition of BA. The nitrogen purge is halted and the reaction is allowed to continue for a further 12 hours. The reaction mixture is allowed to cool and the solvents are virtually completely removed using a rotavapor (rotary evaporator). The residue obtained is dispersed in water and lyophilized. The polymers are analysed by carbon 13 nuclear magnetic resonance and by measuring their acid content.
The number-average molecular mass of the copolymer is 15 000.
The glass transition temperature of the PBA hydrophobic block is -54° C., and 105° C. for the PAA block.
The surface tension is 58.8 mN/m at 10⁻⁴ mol/l.

### EXAMPLE 4

### Preparation of an 80/20 by weight (BA)-b-p(AA) (poly(butyl acrylate)-poly(acrylic acid)) diblock polymer comprising a reactive end of the xanthate type

The following mixture:
0.61 g of xanthate-A, S-ethylpropionyl O-ethyl dithiocarbonate (hereinafter known as xanthate),
4.21 g of isopropanol, and
0.16 g of azobisisobutyronitrile (AIBN),
   is introduced into a reactor equipped with a magnetic stirrer and a reflux column and comprising 160 g of acetone.

The mixture is subsequently stirred and maintained at reflux at 70° C. 8.80 g of acrylic acid (AA) and 30.35 g of water are added gradually over 3 hours. 0.08 g of azobisisobutyronitrile is then added after one hour of addition and then a further 0.08 g of azobisisobutyronitrile is added after a second hour of addition. Once the addition of acrylic acid is complete, the polymerization is allowed to continue for another hour. An amount of 3.7 g of reaction mixture is withdrawn as sample of PAA homopolymer.

The temperature is subsequently lowered to 65° C. by addition of 112 g of acetone. 32 g of butyl acrylate (BA) are gradually added over 3 hours while maintaining the temperature at 65° C. 0.08 g of AIBN is added at the beginning of the addition of BA. The nitrogen purge is halted and the reaction is allowed to continue for a further 12 hours. The reaction mixture is allowed to cool and the solvents are virtually completely removed using a rotavapor (rotary evaporator). The residue obtained is dispersed in water and lyophilized. The polymers are analysed by carbon 13 nuclear magnetic resonance and by measuring their acid content.
The number-average molecular mass is 15 000.
The glass transition temperature of the PBA hydrophobic block is: -54° C., and 105° C. for the PAA block.

### EXAMPLE 5

### Preparation of a 55/45 by weight p(BA)-b-p(AA) (poly(butyl acrylate)-poly(acrylic acid)) diblock polymer comprising a reactive end of the xanthate type

The following mixture:
0.61 g of xanthate-A, S-ethylpropionyl O-ethyl dithiocarbonate (hereinafter known as xanthate),
4.31 g of isopropanol, and
0.17 g of azobisisobutyronitrile (AIBN),
   is introduced into a reactor equipped with a magnetic stirrer and a reflux column and comprising 160 g of acetone.

The mixture is subsequently stirred and maintained at reflux at 70° C. 19.80 g of acrylic acid (AA) and 30.31 g of water are added gradually over 3 hours. 0.08 g of azobisisobutyronitrile is then added after one hour of addition and then a further 0.08 g of azobisisobutyronitrile is added after a second hour of addition. Once the addition of acrylic acid is complete, the polymerization is allowed to continue for another hour. An amount of 4.76 g of reaction mixture is withdrawn as sample of PAA homopolymer.

The temperature is subsequently lowered to 65° C. by addition of 112 g of acetone. 22 g of butyl acrylate (BA) are gradually added over 3 hours while maintaining the temperature at 65° C. 0.08 g of AIBN is added at the beginning of the addition of BA. The nitrogen purge is halted and the reaction is allowed to continue for a further 12 hours. The reaction mixture is allowed to cool and the solvents are virtually completely removed using a rotavapor (rotary evaporator). The residue obtained is dispersed in water and lyophilized. The polymers are analysed by carbon-13 nuclear magnetic resonance and by measuring their acid content.
The number-average molecular mass of the copolymer is 15 000.
The glass transition temperature of the PBA hydrophobic block is: −54° C., and 105° C. for the PAA block.
The surface tension is 58.0 mN/m at 10⁻⁴ mol/l.

### EXAMPLE 6

### Preparation of a diblock polymer with a p(BA)/p(AM) ratio by weight: 60/40 p(BA)₃₀₀₀-b-p(AM)₂₀₀₀ (poly(butyl acrylate)-polyacrylamide) comprising a reactive end of the xanthate type

1) Stage 1: Synthesis of the p(BA)₃₀₀₀-X (X=Xanthate) Monoblock

Composition of the Reaction Mixture:

| | |
|---|---|
| Tetrahydrofuran | 66.38 g |
| Butyl acrylate | 24.00 g |
| Xanthate A | 1.664 g |
| AIBN (Azobisisobutyronitrile) | 0.263 g |

The above ingredients are charged to a 250 ml polymerization reactor equipped with a magnetic stirrer. The reaction is carried out under a dry nitrogen atmosphere for 20 min and the reaction mixture is subsequently heated to 60° C. and maintained at this temperature for 20 hours. Small amounts of samples of polymers are withdrawn from time to time to monitor the conversion. The content of solid material is 28.09%.

2) Stage 2: Synthesis of the p(BA)₃₀₀₀-b-p(AM)₂₀₀₀-X Diblock

Composition of the Reaction Mixture:

| | |
|---|---|
| Tetrahydrofuran | 63.00 g |
| Acrylamide | 16.00 g |
| AIBN (Azobisisobutyronitrile) | 0.263 g |

The above ingredients are charged to a dry receptacle under a dry nitrogen atmosphere for 20 min and then transferred into the polymerization reactor using a syringe with 2 nozzles. At the end of the transfer, the reaction mixture is subsequently heated to 60° C. and maintained at this temperature for 20 hours. Small amounts of samples of polymers are withdrawn from time to time to monitor the conversion. The content of solid material is 24.59%. The reaction mixture is allowed to cool and the solvents are virtually completely removed using a rotavapor (rotary evaporator).
The number-average molecular mass of the copolymer is 5 000.
The glass transition temperature of the PBA hydrophobic block is −54° C., and 165° C. for the PAM block.
The surface tension is 58 mN/m.

### EXAMPLE 7

### Preparation of a diblock polymer with a p(BA)/p(AA) ratio by weight: 80/20 p(BA)₄₀₀₀-b-p(AA)₁₀₀₀ (poly(butyl acrylate)-poly(acrylic acid)) comprising a reactive end of the xanthate type in ethanol

1) Stage 1: Synthesis of the p(BA)₄₀₀₀-X Monoblock

Composition of the Reaction Mixture:

| | |
|---|---|
| Ethanol | 79.00 g |
| Butyl acrylate | 32.00 g |
| Xanthate A | 1.664 g |
| AIBN (Azobisisobutyronitrile) | 0.263 g |

The above ingredients are charged to a 250 ml polymerization reactor equipped with a magnetic stirrer. The reaction is carried out under a dry nitrogen atmosphere for 20 min and the reaction mixture is subsequently heated to 60° C. and maintained at this temperature for 20 hours. Small amounts of samples of polymers are withdrawn from time to time to monitor the conversion. The content of solid material is 30.04%.

2) Stage 2: Synthesis of the p(BA)₄₀₀₀-b-p(AA)₁₀₀₀-X Diblock

Composition of the Reaction Mixture:

| | | |
|---|---|---|
| Ethanol | 19.00 | g |
| Acrylic acid | 8.00 | g |
| AIBN (Azobisisobutyronitrile) | 0.066 | g |

The above ingredients are charged to a dry receptacle under a dry nitrogen atmosphere for 20 min and then transferred into the polymerization reactor using a syringe with 2 nozzles. At the end of the transfer, the reaction mixture is subsequently heated to 60° C. and maintained at this temperature for 20 hours. Small amounts of samples of polymers are withdrawn from time to time to monitor the conversion.
The content of solid material is 30%.
The reaction mixture is allowed to cool and the solvents are virtually completely removed using a rotavapor (rotary evaporator).
The number-average molecular mass of the copolymer is 5 000.
The glass transition temperature of the pBA hydrophobic block is −54° C., and 105° C. for the pAA block.

### EXAMPLE 8

### Synthesis of the p(BA)₇₅₀₀-b-p(AA)₇₅₀₀-X diblock with a p(BA)/p(AA) ratio by weight: (50/50)

A) Stage 1: Synthesis of the p(BA) ₇₅₀₀-X Monoblock

Composition of the Reaction Mixture:

| | |
|---|---|
| Tetrahydrofuran | 48.00 g |
| Butyl acrylate | 20.00 g |
| Xanthate A | 0.555 g |
| AIBN (Azobisisobutyronitrile) | 0.088 g |

The above ingredients are charged to a 250 ml polymerization reactor equipped with a magnetic stirrer. The reaction is carried out under a dry nitrogen atmosphere for 20 min and the reaction mixture is subsequently heated to 60° C. and maintained at this temperature for 20 hours. Small amounts of samples of polymers are withdrawn from time to time to monitor the conversion. The content of solid material is 30.2%.

2) Stage 2: Synthesis of the p(BA)₇₅₀₀-b-p(AA)₇₅₀₀-X Diblock

Composition of the Reaction Mixture:

| | |
|---|---|
| Tetrahydrofuran | 47.00 g |
| Acrylic acid | 20.00 g |
| AIBN (Azobisisobutyronitrile) | 0.088 g |

The above ingredients are charged to a dry receptacle under a dry nitrogen atmosphere for 20 min and then transferred into the polymerization reactor using a syringe with 2 nozzles. At the end of the transfer, the reaction mixture is subsequently heated to 60° C. and maintained at this temperature for 20 hours. Small amounts of samples of polymers are withdrawn from time to time to monitor the conversion.
The content of solid material is 30%.
The reaction mixture is allowed to cool and the solvents are virtually completely removed using a rotavapor (rotary evaporator).
The number-average molecular mass of the copolymer is 15 000.
The glass transition temperature of the p(BA) hydrophobic block is −54° C., and 105° C. for the p(AA) block.
The surface tension is 55 mN/m.

### EXAMPLE 9

### Synthesis of the p(BA)₁₀₀₀-b-p(AA)₄₀₀₀-X diblock with a p(BA)/p(AA) ratio by weight: (20/80)

A) Stage 1: Synthesis of the p(BA)₁₀₀₀-X Monoblock

The procedure of stage A) of Example 8 is repeated exactly, except that the reaction mixture:

| | | |
|---|---|---|
| Tetrahydrofuran | 23.00 | g |
| Butyl acrylate | 8.00 | g |
| Xanthate A | 1.664 | g |
| AIBN (Azobisisobutyronitrile) | 0.263 | g, |

is used.
The content of solids is 30.2%.
   B) Stage 2: Synthesis of the p(BA)₁₀₀₀-b-p(AA)₄₀₀₀-X Diblock

The procedure of stage B) of Example 8 is repeated exactly, except that the reaction mixture:

| | |
|---|---|
| Tetrahydrofuran | 75.00 g |
| Acrylic acid | 32.00 g |
| AIBN (Azobisisobutyronitrile) | 0.263 g, |

is used.

The reaction mixture is allowed to cool and the solvents are virtually completely removed using a rotavapor (rotary evaporator).
The number-average molecular mass of the copolymer is 5 000.
The glass transition temperature of the pBA hydrophobic block is −54° C., and 105° C. for the pAA block.
The surface tension is 45.11 mN/m.

### EXAMPLE 10

### Synthesis of the p(BA)₂₀₀₀-b-p(AM)₃₀₀₀-X diblock with a p(BA)/p(AM) ratio by weight: (40/60)

A) Stage 1: Synthesis of the p(BA)₁₀₀₀-X Monoblock

The procedure of stage A) of Example 8 is repeated exactly, except that the reaction mixture:

| | |
|---|---|
| Tetrahydrofuran | 30.00 g |
| Butyl acrylate | 16.00 g |
| Xanthate A | 1.664 g |
| AIBN (Azobisisobutyronitrile) | 0.263 g, |

is used.
The content of solids is 37.4%.
   B) Stage 2: Synthesis of the p(BA)₂₀₀₀-b-p(AM)₃₀₀₀-X Diblock

The procedure of stage B) of Example 8 is repeated exactly, except that the reaction mixture:

| | | |
|---|---|---|
| Tetrahydrofuran | 100.00 | g |
| Acrylamide | 24.00 | g |
| AIBN (Azobisisobutyronitrile) | 0.263 | g, |

is used.

The reaction mixture is allowed to cool and the solvents are virtually completely removed using a rotavapor (rotary evaporator).
The number-average molecular mass of the copolymer is 5 000.
The glass transition temperature of the p(BA) hydrophobic block is −54° C., and 165° C. for the p(AM) block.
The surface tension is 52 mN/m.

### EXAMPLE 11

### Stage of decomposition of thiocarbonylthio (dithiocarbonate or xanthate) at the chain end of the copolymers

This decomposition stage is general and applies to all the copolymers of Examples l to 10: 0.09 g of triethanolamine is added to a 30% by weight solution in tetrahydrofuran of 6 g of a copolymer as obtained in any one of Examples 1 to 10 in a sealed receptacle equipped with a magnetic stirrer. The receptacle is stirred and heated at 160° C. in an oil bath for 16 h. The polymer which has been rendered inert is characterized by ¹³C NMR. The ratio of the C═S groups at 216 ppm to the C═O groups in the polymer at 176 ppm decreases as a function of the reaction time. The C═S groups disappear at the end of the reaction.

1-13. (canceled)

14. A surface-active block copolymer comprising at least one hydrophilic block and at least one hydrophobic block, prepared by a “living” preparation process using a transfer agent, the said copolymer exhibiting:
the hydrophilic block derives from acrylic acid, methacrylic acid or acrylamide,
the hydrophobic block derives from monomers consisting essentially of n-butyl acrylate or n-butyl methacrylate,
a number-average molecular mass of between 1 000 and 50 000,
a glass transition temperature of the hydrophobic block of less than 30° C., and greater than −100° C., and
a surface tension of less than 60 millinewtons per metre (mN/m), measured at a concentration in demineralized water of less than or equal to 10⁻⁴ mol/l at 20° C. and under one atmosphere.

15. The surface-active block copolymer according to claim 14, wherein the transfer agent is a dithioester, a thioethers-thione, a dithiocarbamate or a xanthate.
